(19) United States
(12) Patent Application Publication
(10) Pub. No.: US 2010/0046919 A1
(43) Pub. Date: Feb. 25, 2010

(54) RECORDING PLAYBACK DEVICE IN IMAGE DISPLAY APPARATUS AND METHOD THEREOF

(76) Inventor: Jun-Yong Song, Pyeongtaek-si (KR)

Correspondence Address: KED & ASSOCIATES, LLP, P.O. Box 221200, Chantilly, VA, 20153-1200, US

(21) Appl. No.: 12/545,319

(22) Filed: Aug. 21, 2009

(30) Foreign Application Priority Data
Aug. 22, 2008 (KR) 10-2008-0082171

(51) Int. Cl. H04N 5/91; G06F 3/00

(52) U.S. Cl. 386/95; 715/719; 386/E05.002

(57) ABSTRACT

Provided are a recording playback device in an image display apparatus and a method thereof. In the recording playback method, at least one bookmark is received from a user during playback of a recording stored in an internal or external memory. The at least one bookmark is stored. The recording is played back from the bookmarked point by a user's request.

### CROSS-REFERENCE TO RELATED APPLICATIONS

The present application claims priority under 35 U.S.C. 119 and 35 U.S.C. 365 to Korean Patent Application No. 10-2008-0082171 (filed on Aug. 22, 2008), which is hereby incorporated by reference in its entirety.

### BACKGROUND

The present disclosure relates to an image display apparatus, and more particularly, to a recoding playback device in an image display apparatus and a method thereof.

Recently, with the development of digital data storage media technologies, digital-type data recording playback devices are being widely distributed instead of typical analog-type data recording/playback devices.

In the digital-type data recording/playback devices, analog- or digital-type image signal data are compressed and stored in a digital form, and decoded and displayed on a display device such as a monitor when a user plays back the stored data.

In these digital data recording/playback in these image display devices or from an external storage media, it is inconvenient for a user to find a specific position that a user desires. Particularly, when a user re-watches desired recordings, the user must remember a playback point and search for an adjacent playback point. Also, when a user resumes watching of a recording that the user stopped watching, the user must find an adjacent playback position.

Furthermore, even when a user finds a corresponding playback point, information on the playback point is lost after the playback of a recording. Accordingly, the user must find the playback again whenever he/she watches.

### SUMMARY

Embodiments provide a recoding playback device in an image display apparatus and a method thereof, which allow a user to easily watch an image at a point that a user desires during playback of recordings.

Embodiments also provide a recoding playback device in an image display apparatus and a method thereof, which allow a user to play back a recording from a point that a user desires even when a plurality of users watch one recording.

Embodiments also provide a recoding playback device in an image display apparatus and a method thereof, which allow a user to set a plurality of bookmarks during watching recordings.

In one embodiment, a recording playback method in an image display apparatus comprises: receiving at least one bookmark from a user during playback of a recording stored in an internal or external memory; storing the at least one bookmark; and playing back the recording from the bookmarked point by a user's request.

### BRIEF DESCRIPTION OF THE DRAWINGS

FIG. 1 is a view illustrating an image display apparatus according to an embodiment.

FIG. 2 is a flowchart illustrating an exemplary bookmark setting operation in a recording playback according to an embodiment.

FIG. 3 is a view illustrating an exemplary bookmark setting display in a recording playback according to an embodiment.

FIG. 4 is a flowchart illustrating an exemplary recording playback operation according to an embodiment.

FIG. 5 is a view illustrating an exemplary recording list display according to an embodiment.

FIG. 6 is a view illustrating an exemplary playback target selection display in recording list display according to an embodiment.

### DETAILED DESCRIPTION OF THE EMBODIMENTS

Reference will now be made in detail to the embodiments of the present disclosure, examples of which are illustrated in the accompanying drawings.

Hereinafter, preferred embodiment will be described in detail with reference to the accompanying drawings.

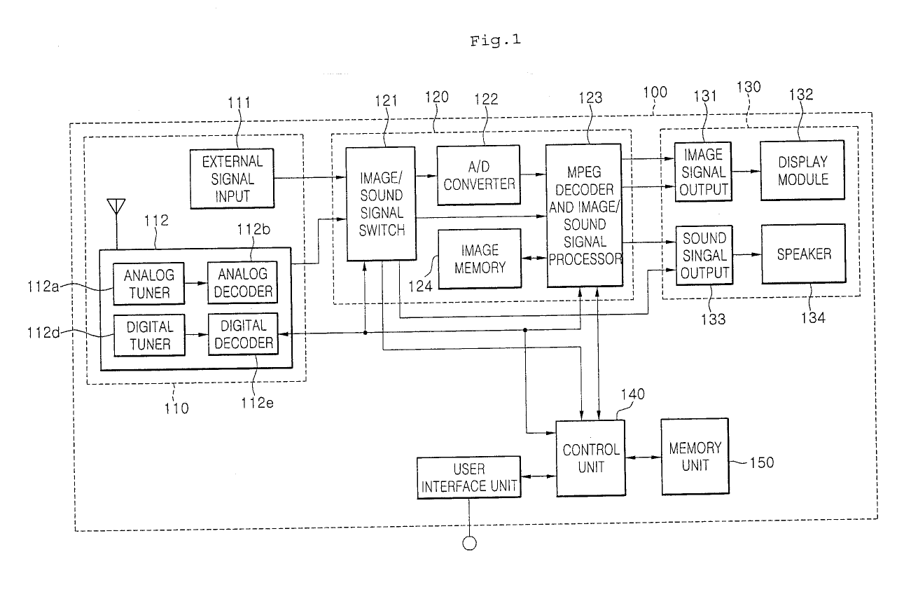

FIG. 1 is a view illustrating an image display apparatus according to an embodiment.

The image display apparatus may include a reception unit 100, a processing unit 120, an output unit 130, a control unit 140, a memory unit 150, and an interface unit 170.

The reception unit may include an external signal input 111 and a tuner 112.

The processing unit 120 may include an image/sound signal switch 121, an A/D converter 122, an MPEG decoder and image/sound signal processor 123, and an image memory 124.

The output unit 130 may include an image signal output 131, a display module 132, a sound signal output 133, and a speaker 134. The external signal input 111 receives external signals from external devices such as Digital Versatile Disks (DVDs), set top boxes, and camcorders, and provides the signals to the image/sound signal switch 121. Particularly, the external signal input 111 reads recordings from an external storage media (for example, USB memory) for playback, or performs an interface function of downloading/uploading the recording to the memory unit 150 of the image display apparatus.

The tuner 112 tunes at least one channel according to a control signal of the control unit 140, and decodes or separates the image/sound/data signal received through the tuned channel to provide to the image/sound signal switch 121. The data signal includes Electric Program Guide (EPG) information such as information on the start and end time of broadcast programs that are broadcasted on the channel.

The data signal may be decoded into data information by a decoder. The control information, which is a part of the data information, is delivered to the control unit 140 directly or indirectly. The control unit 140 may search for another channel broadcasting the same contents as broadcasted on the current channel by using the control information.

The tuner 112 may include an analog tuner 112a receiving analog signals, a digital tuner 112d receiving digital signals, an analog decoder 112b decoding the analog signals, and a digital decoder 112e decoding the digital signals.

Image/sound signals outputted from the digital decoder 112e have Transport Stream (TS) form. The image/sound signal switch 121 selects at least one of channels provided from the external signal input 111 and the tuner 112 to separate image/sound signals from the channel if necessary. Then the image/sound signal switch 121 provides the image/sound signal to the MPEG decoder and image/sound signal processor 123 The image/sound signal switch 121 may include a demultiplexer that can separate image/sound/data signals.

When the signal selected by the image/sound signal switch 121 is an analog signal, an image signal and a sound signal are separated from the signal. The A/D converter 122 converts the analog image signal into a digital image signal to provide to the MPEG decoder and image/sound signal processor 123. The analog sound signal may be provided to the sound signal output 133.

The analog image signal is recovered and processed by the MPEG decoder and image/sound signal processor 123. The processed image signal is provided to the image signal output 131, and the processed sound signal is provided to the sound signal output 133. Also, the MPEG decoder and image/sound signal processor 123 may mix the recovered and processed image signal with On Screen Display (OSD) data provided from the control unit 140.

The image signal output 131 processes the image signal outputted from the MPEG decoder and image/sound signal processor 123 into an outputtable form through the display module 132. The sound signal output 133 processes the sound signal outputted form the MPEG decoder and image/sound signal processor 123 into an outputtable form through the speaker 134.

For example, the interface unit 160 may be a local key button attached to a remote controller or an image device, and receive various commands and information from a user to convert into control signals and deliver to the control unit 140. Particularly, the interface unit 160 is used to receive bookmarks from a user, and serves as a means receiving a playback request or a stop request of recordings. Also, when a plurality of bookmarks are set, the interface unit 160 is used as a means receiving identifier information such as titles of the respective bookmarks.

The control unit 140 controls a tuner 112, an image/sound signal switch 121, and an MPEG decoder and image/sound signal processor 123. The control unit 140 may control other components of the image display apparatus.

Particularly, the control unit 140 may read out and play back images that have already been stored in an internal memory 150 or external storage media according to the playback request and the stop request of recordings. Otherwise, the recordings stored in the external storage media may be downloaded to the internal memory. In this case, various information such as the title and play time of the downloaded recordings may be verified to determine whether the same recording exists. Particularly, the control unit 140 recognizes at least one bookmark requested by a user during playback, and saves the corresponding playback point. Accordingly, the control unit 140 may perform a playback from the playback point bookmarked by user's request.

Particularly, the control unit 140 may store a bookmark including a thumbnail corresponding to the bookmarked point.

The memory unit 150 stores data inputted by a user and data generated and managed by the control unit 140. Accordingly, various broadcast recordings received through the tuner 112 or recordings stored in various external storage media that are accessed through the external signal input 111 are read out and stored. Also, the memory unit 150 performs a function of storing information on at least one bookmark inputted by a user's request during playback of recordings. The bookmark may be included in header information of the recording, or may be separately stored in bookmark information including information on the recording.

According to an embodiment, if a playback request of a recording is inputted from a user, the corresponding recording is played back. If a bookmark input request signal is inputted during the playback of the recording, a function of recognizing the corresponding playback point as a bookmark point may be performed.

The bookmarked point may be a point by a user's request or a point where the playback is stopped.

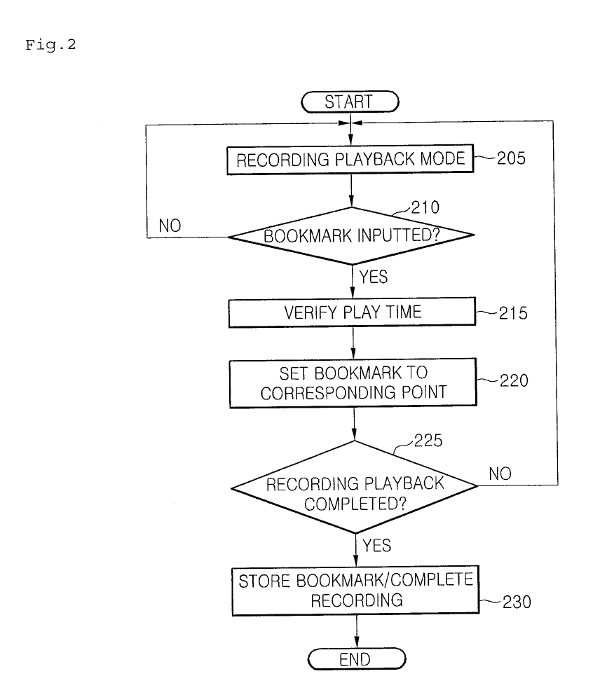

By using the configuration of the above image display device, a recording playback method in an image display apparatus according to an embodiment will be described in detail with reference to FIGS. 2 through 4.

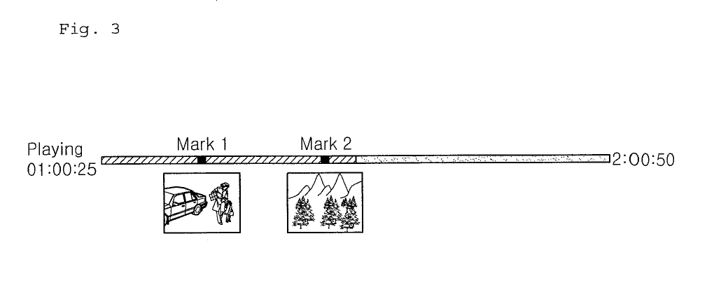

FIG. 2 is a flowchart illustrating an exemplary bookmark setting operation in a recording playback according to an embodiment. FIG. 3 is a view illustrating an exemplary bookmark setting display in a recording playback according to an embodiment.

In operation S205, a control unit 140 performs a playback mode of recordings stored in a memory unit 150 or inputted through an external signal input 111 by a user's request. In operation S210, when detecting a certain input signal during the recording playback mode, the control unit 140 determines whether the input signal is a bookmark input signal.

In operation S215, when a bookmark input signal is inputted from a user during the recording playback, the control unit 140 verifies the play time of the recording at the time when the bookmark is inputted. In operation S220, the control unit 140 may set the verified play time as a bookmark point as described in FIG. 3, and store the title of the bookmarked point or various identifier information of titles that users may easily recognize. Also, when the bookmark is set, the control unit 140 may store a still image of the corresponding playback point as a thumbnail.

In operation S225, the control unit 140 receives whether the current recording playback will be continued after the setting of the bookmark. In operation S230, the control unit may continue the recording playback from the bookmark setting point, or stop the recording play.

On the contrary, when the playback of the recording is stopped without setting a bookmark, a message informing whether a bookmark is set may be displayed. Accordingly, the user may set a bookmark at the point when the playback is stopped. Otherwise, the point when the playback is ended may be set as a bookmark point.

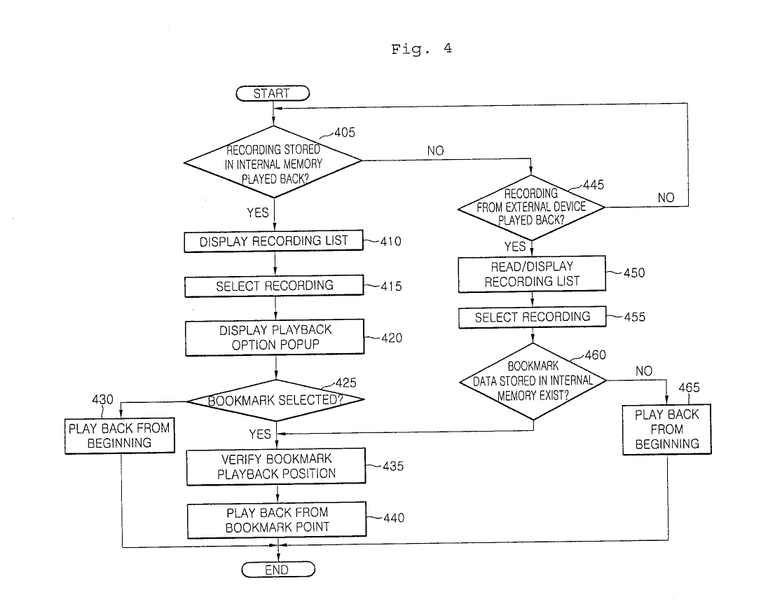

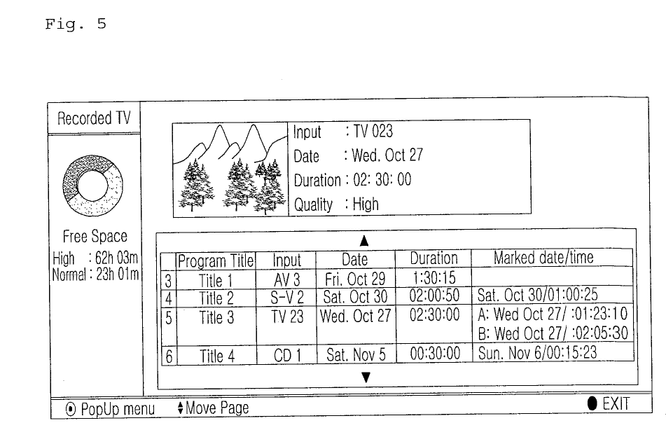

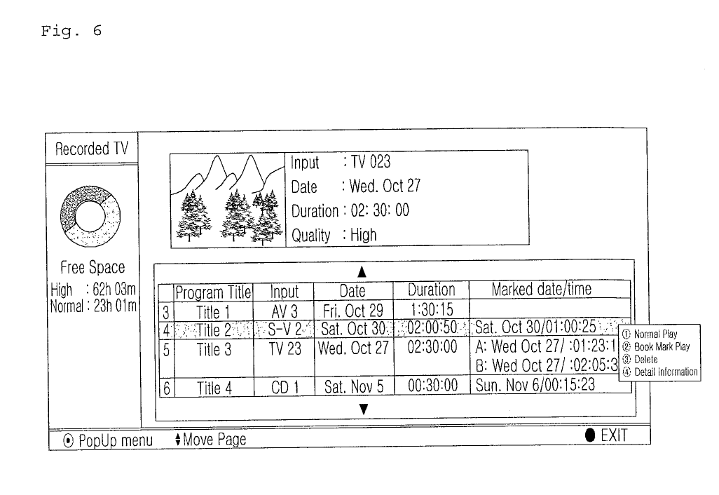

At least one bookmark on the recording may be set and stored by the user's request during the recording playback. FIG. 4 is a flowchart illustrating an exemplary recording playback operation according to an embodiment. FIG. 5 is a view illustrating an exemplary recording list display according to an embodiment. FIG. 6 is a view illustrating an exemplary playback target selection display in recording list display according to an embodiment. A recording playback operation according to an embodiment will be described in detail with reference to FIGS. 4 through 6.

When a recording playback request signal for requesting a playback of a recording stored in the memory unit 150 or an external memory inputted by a user, the control unit 140 verifies the stored position of the recording. In operation S405, the control unit 140 determines whether a playback request of a recording stored in the internal memory unit 150 of the image display apparatus upon playback request of the recordings. In operation S410, the control unit 140 displays the recording list stored in the memory unit 150 as described in FIG. 5.

In operation S410, when one recording among the recording list is selected by the user, in operation S420, the control unit 140 displays a popup window that allows the user to select the playback options of the recording as described in FIG. 6.

In operation S430, the control unit 140 determines whether an item on the displayed popup window selected by the user is a bookmark, and performs a new playback of the recording from beginning if the user does not intend to resume a playback from the bookmark. Particularly, upon display of the popup window, the bookmark list may be activated or inactivated on the display according to whether bookmarks exist.

Otherwise, by displaying an already-stored thumbnail image related to the bookmark when the bookmark information is displayed on the recording list, the user may easily identify the bookmark information.

In operation S435, if a signal that requests a playback from the bookmark point of the recording is inputted by a user, the control unit 140 verifies the bookmarked playback point. In operation S440, the control unit 140 plays back the recording from the corresponding bookmark point.

In operation S445, the control unit 140 determines whether the recording playback request by the user is a playback request not for recordings stored in the internal memory but for recordings that are read out from external devices. In operation S450, the control unit 140 allows the list of recordings stored in the external device to be displayed on the display module 132.

After a recording is selected by a user in operation S455, the control unit 140 determines whether bookmark information on the selected recording is stored in the internal memory in operation S460. That is, in operation S460, when already-set bookmarks on the recordings that is read out from the external devices exist, the control unit 140 determines whether the corresponding bookmark information is generated as a bookmark data and stored in the internal memory together with information on the recordings.

In operation S465, if there is no bookmark information, the control unit 140 performs a general recording playback operation that plays the corresponding recordings from beginning, and allows the recording playback to be resumed from the corresponding point according to the bookmark information in operation S440. In this case, if there is information on a plurality of bookmarks, one bookmark may be selected to be played back from the corresponding point like the bookmark playback of the recordings stored in the internal memory.

As described above, when a recording playback request for recordings including bookmarks inputted by a user occurs, requests of the bookmarks or general recording playback are inputted to play back the recordings from the corresponding point.

According to the embodiments, it has been described as an example that, when recordings including a bookmark are played back by a user's request, the bookmark is selected and the recordings are played back from a bookmark point.

Even when the recordings are being played back, the playback may be re-performed from the bookmark point after the recording is rewound to that bookmark point. That is, at least one bookmark is set and stored by a user during playback of the recordings. After this, if another playback request signal to play back from a bookmarked point is inputted during the playback of the recordings, then the play time of the recordings may be returned to the bookmarked point, and the recordings may be played back from the bookmarked point.

If there are a plurality of bookmarks, bookmarked information is displayed through a popup window or an OSD. Also, a user may be allowed to select one of the plurality of bookmarks to play back the recordings from a corresponding point. Otherwise, the bookmarked point is displayed on a progress bar that is temporarily or continuously displayed during the playback of the recordings. Then, the user may select a bookmark point displayed on the progress bark to play back the recordings from the corresponding point.

According to the embodiments, it has been described as an example that already-stored recordings in an internal memory or external storage medium are read out and played back.

Although recordings are received from an external server and played back, information bookmarked by a user may be stored in the inner memory. Accordingly, even when identical recordings from the external server are played back, or recordings are being played back, the recordings may be played back from a bookmarked point.

The embodiments have an advantage in that a user can easily find a desired playback point in watching of recordings.

Also, the embodiments have an advantage in that a user can easily watch recording at a desired playback point even when a plurality of users watch one recording.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A recording playback method in an image display apparatus, the method comprising:
receiving at least one bookmark from a user during playback of a recording stored in an internal or external memory;
storing the at least one bookmark; and
playing back the recording from the bookmarked point by a user's request.

2. The method according to claim 1, wherein, if a plurality of bookmarks are inputted, identifier information on each bookmark is inputted and stored.

3. The method according to claim 1, comprising verifying whether a bookmark of a corresponding recording exists, upon recording playback request by the user,
wherein, if there is at least one bookmark, the recording is played back from a corresponding point by receiving a selection of one bookmark.

4. The method according to claim 1, comprising:
verifying whether a bookmark of the corresponding recording exists, upon recording playback request by the user;
displaying a message that verifies whether to play back the recording from a corresponding bookmark point if the bookmark exists; and
playing back the recording from the bookmark point by the user's request.

5. The method according to claim 1, wherein information on the bookmark is stored header information of the recording.

6. The method according to claim 1, wherein bookmark data corresponding to the recording is generated and stored when a bookmark is inputted during the playback of the recording.

7. The method according to claim 6, wherein, if the recording is a recording stored in the external memory, the generated bookmark data is stored in the internal memory together with information on the recording.

8. The method according to claim 1, comprising verifying bookmark data stored in the internal memory upon play request of the recording stored in the external memory;
wherein, if there is bookmark data on the playback-requested recording stored in the external memory, the recording is played back from the corresponding bookmark point.

9. The method according to claim 1, wherein the storing of the at least one bookmark comprises storing a thumbnail of the bookmarked point.

10. A recording playback method in an image display apparatus, the method comprising:
receiving at least one bookmark from a user during playback of a recording received from the outside;
storing information on the at least one bookmark in the image display apparatus; and
verifying the bookmark information to play back the recording from a corresponding point if a playback request for playing back the recording from the bookmarked point is made by a user.

11. A recoding playback device in an image display apparatus comprising:
a memory unit storing recordings and at least one bookmark information inputted from a user during playback of the recording;
a display unit displaying the recordings stored in the memory unit;
an audio output unit outputting audios corresponding to the displayed recordings;
a user interface unit receiving a recording selection and at least one bookmark from the user during the playback of the recordings; and
a control unit determining whether a bookmark of the recording exists upon playback request of the recording and controlling the recording to be played back from a play time corresponding to the bookmark.

12. The recording playback device according to claim 11, wherein the memory unit generates and stores bookmark data comprising information on a corresponding recording when at least one bookmark selected by the user is stored.

13. The recording playback device according to claim 11, wherein, if there are a plurality of the received bookmarks, the control unit displays a popup menu that allows the user to select a bookmark of the corresponding recording on the display unit upon recording playback request by the user, and plays back the recording from the play time corresponding to the selected bookmark.

14. The recording playback device according to claim 11, wherein, upon playback request of a recording stored in an external input device connected to the external signal input unit, the control unit verifies the bookmark data stored in the memory unit to play back the recording from a bookmark point of the recording.

15. The recording playback device according to claim 11, wherein the image display apparatus further comprises an external signal input unit connecting an external memory to play back the recordings stored in the external memory.

16. The recording playback device according to claim 14, wherein, if there are a plurality of bookmarks received from the user, the control unit allows each identification information on the bookmarks to be inputted and stored through the user interface unit.

17. The recording playback device according to claim 11, wherein the memory unit stores a thumbnail of a bookmarked point when the bookmark information is stored.

18. The recording playback device according to claim 16, wherein the display unit displays a list of the recordings including a thumbnail corresponding to the bookmark.
